(19) United States
(12) Patent Application Publication
(10) Pub. No.: US 2015/0266538 A1
(43) Pub. Date: Sep. 24, 2015

(54) BICYCLE BRAKE DEVICE AND ASSEMBLY

(71) Applicants: Aziz Fattahi, Davis, CA (US); Andrew P. Spiropoulos, Davis, CA (US)

(72) Inventors: Aziz Fattahi, Davis, CA (US); Andrew P. Spiropoulos, Davis, CA (US)

(21) Appl. No.: 14/218,910

(22) Filed: Mar. 18, 2014

(51) Int. Cl. B62L 1/10; B62L 3/02

(52) U.S. Cl. CPC B62L 1/10; B62L 3/02

(57) ABSTRACT

A mechanical power brake assembly for the rear wheel of a bicycle that magnifies the manual force applied to asymmetric brake shoes so as to induce a greater force through the hand lever, cable and brake arms. The force applied to the brake pad gripping surface induces a greater force by harnessing the forward momentum of the bicycle. An increase in the forward momentum of the bicycle results in a greater magnification of the force to the brake shoe. In one embodiment of the brake assembly, each brake shoe is configured to pivot on a connecting rod. In another embodiment of the brake assembly, the brake shoes are secured with a saddle that pivots within each brake arm configured as a cantilever. An embodiment of the asymmetric brake shoe may be mounted on any existing brake arms without requiring a proprietary brake arm assembly.

### CROSS-REFERENCE TO RELATED APPLICATION

This application claims the benefit of U.S. Provisional Application Ser. No. 61/803,030, filed Mar. 18, 2013, the content of which is hereby incorporated herein by reference.

### BACKGROUND OF THE INVENTION

The present invention relates to the field of bicycles. This invention more particularly relates to a bicycle brake apparatus having asymmetrical pads and a process for reducing the speed of a moving bicycle.

Currently, bicycle brake shoes (pads) are fastened to the brake arms by a bolt (connecting rod) that is centered to the frame of the shoe. In forward motion, the brake surface grasps the wheel rim so as to slow the speed of the bicycle using the frictional force between the bicycle rim and the brake pad.

In a standard “Linear Pull” type bicycle brake, force is applied to the system by the operator applying pressure on the brake lever. This lever pivots about a bolt and the moment applied to the lever applies tension to the steel brake line and brake line housing, leading to the brake assembly. At the assembly the rigid brake housing and brake cable generate a force couple in the form of tension in the brake line. This force pulls the two brake arm bodies toward the rim of the bicycle. The brake pads are rigidly mounted on the brake arm bodies and come into contact with the rim when the system is under tension. The tension in the system applies a normal force through the brake pad and generates kinetic friction with the surface of the rim. The amount of friction is dependent on the force applied by the operator, the mechanical advantage provided by the geometry of the brake arm body and the coefficient of friction of the pad surface. The mechanical advantage is dependent on the moment pair geometry created by the brake arm body. The first moment is from the tension cable mounting point about the pivot bolt. The second opposing moment is from the brake pad-rim interface and the pivot bolt.

In view of the foregoing, there is a need for, and what was heretofore unavailable, is a bicycle brake assembly having asymmetrical pads. There is a further need for an improved bicycle braking process. The present invention fulfills these and other needs.

### SUMMARY OF THE INVENTION

Briefly, and in general terms, the present invention is directed to a mechanical power brake for the rear wheel of a bicycle. The brake assembly of the present invention magnifies the manual force applied to the brake pads (shoes) so as to induce a greater force through the hand lever, cable and brake arms. In essence a moderate tractive force applied to the brake pads will induce a greater force greater normal force on the pad by harnessing the forward momentum of the bicycle. An increase in the forward momentum of the bicycle results in a greater magnification of the force to the brake.

The power bicycle brake apparatus of the present invention operates in a similar manner to a standard “Linear Pull” type brake apparatus with a significant difference. The brake pad (shoe) of the present invention is not rigidly mounted to a brake arm. Instead, the pad sits on a pivot mechanism. This novel configuration for a rear wheel rim is intended to utilize the inertia of the rider-bicycle during braking to amplify the force generated on the brake pad. When the rider applies pressure to the brake handle, the friction generated at the brake pad will cause the pad to pivot about its axis of rotation.

In the one aspect of the brake assembly of the present invention, the axis of the brake pad is within the brake pad structure such that the magnification of the force of braking is due to the asymmetrical positioned connecting rod design of the brake shoes. In another aspect of the brake assembly that pivot point is in the structure of a brake saddle.

In both assemblies, the angular motion of the brake pad moving about its pivot axis drives the brake pad into the wheel rim with greater force, resulting in greater amounts of friction available for braking. Both embodiments of the brake assembly of the present invention utilize setscrews to limit the angular travel of the brake pad and to keep the surface of the brake pad parallel to the rim on rebound. The setscrews also utilize either a spring or elastomeric bumper as a rebound device to keep the brake pad squared to the wheel after the brake lever is released.

In forward motion, the rim's braking surface is moving towards the pivot point of the brake shoe. The anchor point (pivot point) is in the trailing edge of the shoe. The friction between the wheel rim's braking surface and the brake shoe surface forces an angular motion in the shoe, pulling the leading edge of the brake shoe towards the wheel rim. This movement of the brake shoe is a wedging action in the shoe that amplifies the original force initiated by the operator (rider) of the bicycle.

When the brake handle is released, the breaking will cease and the brake arms will return to an original position and the force of a return spring will return the brake shoe back to a parallel position with respect to the braking surface of the wheel rim. The return spring pressure will be set based on the weight factor of the rider by a spring adjusting screw. The brake shoes may be aligned parallel to the wheel rim by use of an adjusting screw. A stop screw may be provided that is intended to periodically adjust the shoe surface relative to the braking surface of the wheel rim.

The brake shoes (pads) may be made from three or more hardness materials. The hardest material would be formed at the trailing edge of the brake shoe and the softest material would be incorporated into the leading (first engaging) edge of the shoe. The varied hardness of the materials in the brake shoe is for the purpose of achieving even wear of the entire length of the shoe over time.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1A is a schematic representation of a side view of a brake assembly of the present invention depicting a pivoting brake shoe

FIG. 1B is a schematic representation of a front view of a brake assembly of the present invention depicting a pivoting brake shoe.

FIG. 2 is an exploded perspective view of a brake assembly of the present invention including pivoting brake shoes.

FIG. 3 is a front perspective view of an embodiment of a brake assembly having pivoting brake shoes in accordance with the present invention.

FIG. 4 is front perspective view of an embodiment of a pivoting brake shoe and connecting rod in accordance with the present invention.

FIG. 5 is an exploded plan view of an alternate embodiment of a brake assembly of the present invention including cantilever arms configured for pivoting a pair of brake shoes.

FIG. 6 is a front perspective view of the assembled brake assembly of FIG. 5.

FIG. 7 is a front plan view of the embodiment of a brake assembly of FIG. 6.

FIG. 8 is a back perspective view of a cantilever arm in accordance with the present invention.

FIG. 9 is a back perspective view of a brake shoe in accordance with the present invention.

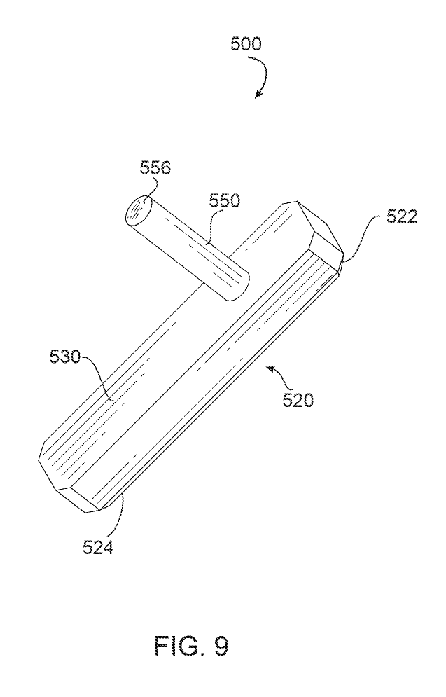

FIG. 10 is a back perspective view of a brake shoe saddle in accordance with the present invention.

FIG. 11 is a side perspective view of a power brake assembly mounted on a bicycle frame in accordance with the present invention.

FIG. 12 is a rear perspective view of a power brake assembly mounted on a bicycle frame in accordance with the present invention.

FIG. 13 is a rear perspective view of a power brake assembly mounted on a bicycle frame in accordance with the present invention, wherein the brake shoes have engaged the rim of a bicycle wheel.

FIG. 14 is a rear perspective view of a power brake assembly mounted on a bicycle frame in accordance with the present invention, depicting the force vectors associated with the brake shoes engaging a moving rim of the bicycle wheel.

FIG. 15 is a front perspective view of an alternative embodiment of a brake shoe in accordance with the present invention.

FIG. 16 is a side perspective view of a the brake shoe of FIG. 15, depicting the force vectors associated with the brake shoe engaging a moving rim of a bicycle wheel.

### DETAILED DESCRIPTION OF THE INVENTION

As shown in the drawings for purposes of illustration, the present invention is directed to a mechanical power brake for the rear wheel of a bicycle. The brake assembly of the present invention magnifies the manual force applied to the brake pads (shoes) so as to induce a greater force through the hand lever, cable and brake arms. In essence, a moderate tractive force applied to the brake pads will induce a greater normal force by harnessing the forward momentum of the bicycle. The greater normal force generates greater friction for the same effort applied on the brake handle by the rider. An increase in the forward momentum of the bicycle results in a greater magnification of the force to the brake shoe.

In the one aspect of the brake assembly of the present invention, the axis of rotation of the brake shoe is within the brake shoe structure such that the magnification of the force of braking is due to an asymmetrical connecting rod design for positioning the brake shoes about the rim of a bicycle. In another aspect of the brake assembly, the axis of rotation of the brake shoe is configured within the structure of a brake saddle pivotally attached to a cantilever arm.

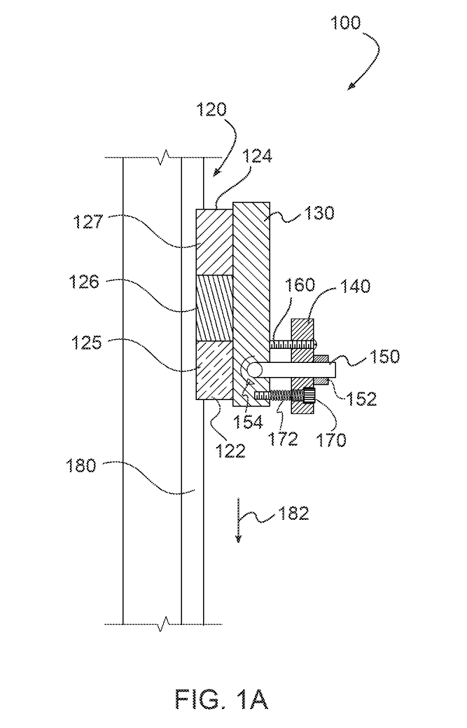

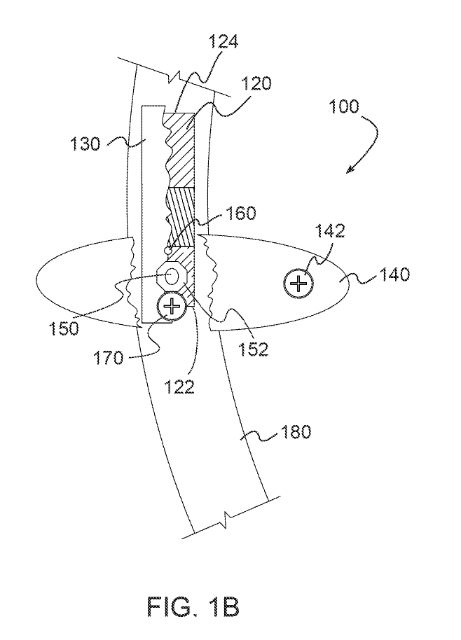

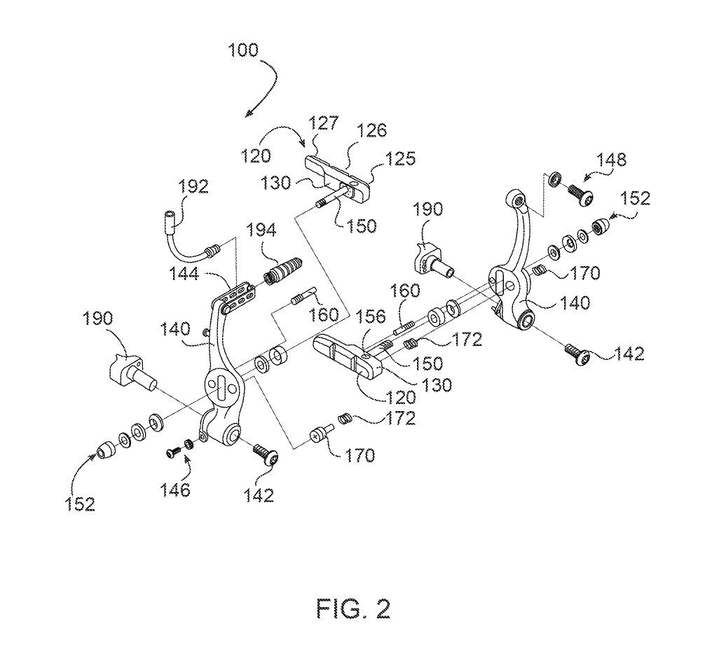

Turning now to the drawings, in which like reference numerals represent like or corresponding aspects of the drawings, and with particular reference to FIGS. 1A, 1B and 2, the bicycle brake assembly 100 of the present invention includes a brake pad 120 having a first end 122 (closest to the bicycle seat), a second end 124 (furthest from the bicycle seat) and a first side surface for contacting (gripping) a rear wheel rim 180 of a bicycle. A brake pad backing 130 is attached to a second side surface (opposite the first side surface) of the brake pad. Herein, the combination of the pad 120 and backing 130 are referred to as the “brake shoe.”

As shown in FIG. 1A, the brake pad 120 may be formed of more than one section, each section of the gripping surface of the brake pad made from a material having a different hardness (durometer). By way of example only, the pad may me formed of a first section 125 being the most soft (having the lowest durometer), the middle section 126 having an intermediate hardness and a third distal section 127 being the hardest (highest durometer). Varying the hardness of the surface of the along the longitudinal length is designed to promote even wear of the pad. Accordingly, the sections of the brake shoe pad may be made from materials of different hardness (durometer), as can be determined by one of ordinary skill in the art without undue experimentation.

Referring again to FIGS. 1A, 1B and 2, the backing of the brake shoe backing 130 is rotatably attached to a connecting rod 150. The connecting rod is fixedly attached to a brake arm 140 that may be secured to the brake shoe the by a locking nut 152 shown in FIG. 1A and FIG. 1B, or, as shown in FIG. 2, by a shoe fixing nut unit. The brake arm may be attached to a bicycle frame 190 by a mounting bolt 142. The brake assembly 100 may further include a level stop screw 160 for adjusting the position of the brake shoe relative to the bicycle rim 180. The assembly may further include a spring adjusting screw 170 and return spring 172 (for example, a metal coil or other force imparting device, such as an elastomer) for pushing the brake shoe away from the bicycle rim when a rider of the bicycle releases the tension on a cable extending from a brake lever operated by the rider.

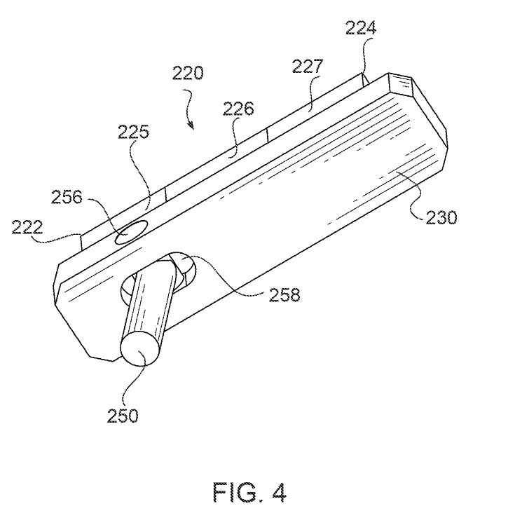

The rotation of the brake shoe is depicted in FIG. 1A by a pivot arrow 154. The brake shoe rotates (pivots) on an axis within the backing 130 of the shoe. The connecting rod 150 is “T” shaped (see FIGS. 2, 4), having ends 156 that may reside with a cavity of the shoe backing. The rear bicycle rim 180 rotates within the two brake arms 140 of the brake assembly 100, as shown by the direction arrow 182. When the rider engages the brake shoe with the bicycle rim, the surface of first end 122 of the brake pad 120 grips the rim, causing the shoe to rotate 154 about the axis formed by the “T” portion of the connecting rod. As the brake pad rotates, the surface of the second end 124 of the brake pad grips the wheel transferring the kinetic force of the rotating wheel into greater normal force on the brake pad. The greater normal force at the pad generates greater friction between the gripping surface of each pad and the rim, thereby reducing the forward speed (momentum) of the bicycle and rider.

As shown in FIG. 2 and by way of example, there are two sets of brake pads 120, shoe backings 130 and brake arms 140 for position on each side (left “L” and right “R”) of the bicycle rim 180. For simplicity of viewing FIG. 2, the part reference numbers are the same for both the left and right sides of the brake assembly 100. The ‘left’ brake arm 140 of the assembly includes a cable keeper 144 attached to the upper portion (away from the wheel rim 180 and towards the bicycle seat) of the brake arm. Each brake arm is attached to the frame 190 by a bolt 142, and the left brake includes a adjustment screw and stopper 146 at the bottom portion (away from the bicycle seat) of the brake arm. The right brake arm includes a cable bolt 148 for retaining the end of the brake cable that passes though a inner cable lead unit 192 secured within the cable keeper and secured by a cable boot 194.

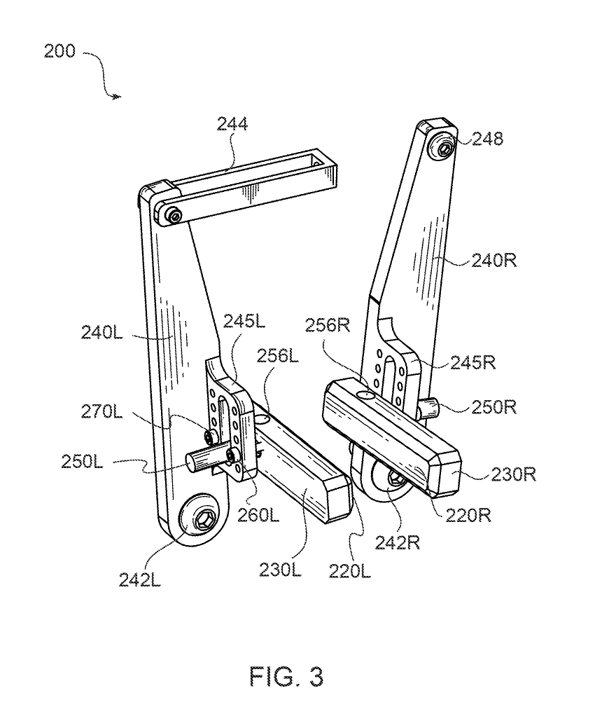

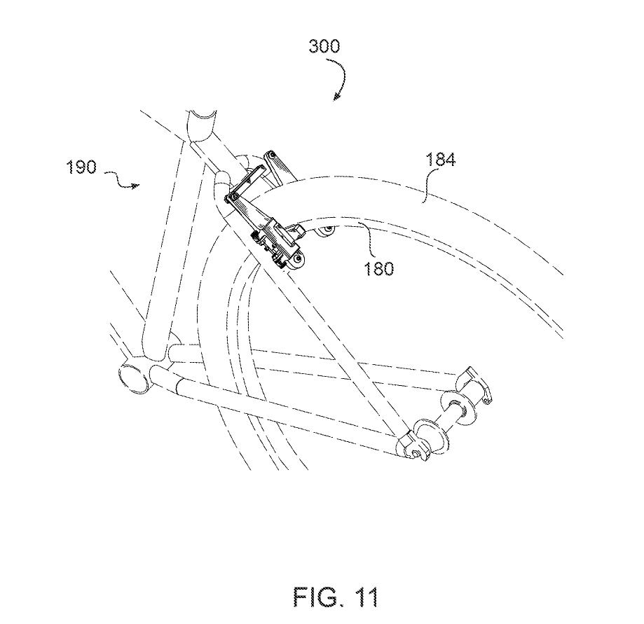

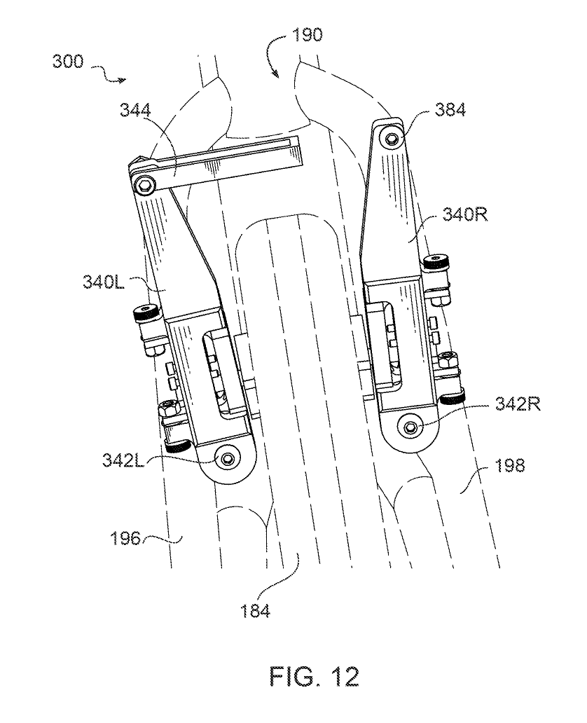

Referring now to FIGS. 3 and 4, and by way of example, an alternative embodiment of the brake assembly 200 includes two sets of brake pads 220L, 220R; shoe backings 230L, 230R; and brake arms 240L, 240R for position on each side of the bicycle rim 180 (see FIG. 11). The ‘left’ brake arm 240L of the assembly includes a cable keeper 244 attached to the upper portion (away from the wheel rim 180 and towards the bicycle seat) of the brake arm. Each brake arm is attached to the frame 190 (see FIG. 12) by a bolt 242L, 242R. The ‘right’ brake arm 240R includes a cable bolt 248 for retaining the end of the brake cable that passes though the cable keeper. Each brake arm is configured with a flange 245L, 245R for retaining the “T” portion 256L, 256R of the connecting rod 250L, 250R disposed within a cavity 258 (FIG. 4) of the shoe backing 230L, 230R. The flanges include one or more holes for retaining a level stop screw 260L, 260R and spring adjusting screw 270L, 270R (force imparting—spring mechanism not shown—see FIG. 2). As shown in FIG. 4, the brake pad 220 may have one or more sections 225, 226, 227 attached to the shoe backing 230. The sections of the brake shoe pad may be made from materials of different hardness (durometer), as can be determined by one of ordinary skill in the art without undue experimentation.

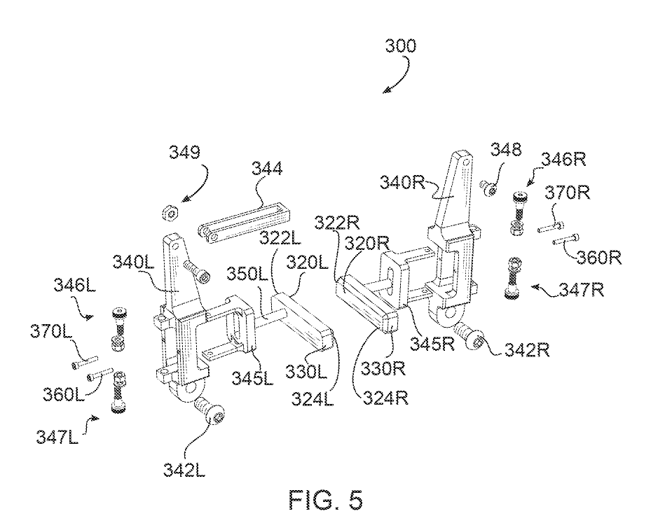

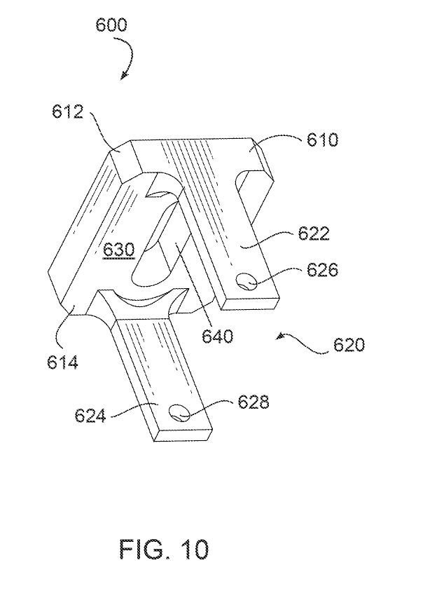

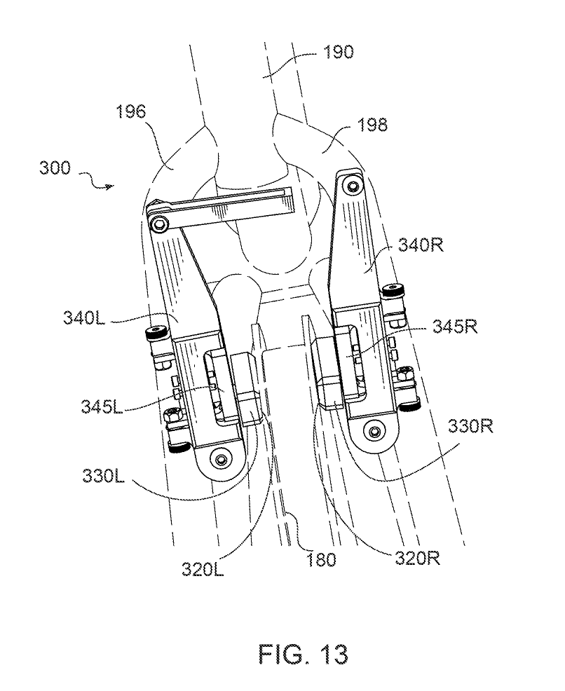

As shown in FIGS. 5, 6 and 7, an alternative embodiment of the power brake assembly 300 of the present invention mounts a standard brake shoe having a backing portion 330L, 330R attached to a gripping surface 320L, 320R for engaging a wheel rim (see FIG. 13). The brake shoe is slidably disposed within into a pivoting saddle 345L, 345R (see FIG. 10). The cantilever brake arm 340L, 340R is preferably made from a high strength alloy, such as 7075-T6, T651 aluminum alloy. The saddle has a pair of arms that have threaded holes to accommodate the shouldered socket head cap screw sets 346L, 347L (346R, 347R) that secure the saddle onto the cantilever arm. A shim (for example, a porous bronze or iron alloy impregnated with an oil lubricant, such as available under the trademark OILITE from the Beemer Precision, Inc. of Fort Washington, Pa.) may be used to fill the space between the saddle arms and the cantilever arm. The cantilever arm is drilled and tapped to accommodate socket head cap screw sets 360L, 360R that may be used to adjust the saddle and brake pad surface relative to the wheel rim as the pad surfaces wear during use. The cantilever arm further is drilled and tapped to accommodate socket head cap screw sets 370L, 370R that will limit angular travel, square the saddle for its rest position and set a spring/elastomer preload. The cable keeper 344 restrains a brake cable housing so that a brake cable can apply tension at the socket button head cap screw 348 that captures the steel brake line (not shown). This configuration squeezes both sides of the braking system against the bicycle wheel rim.

During use of the brake assembly 300 and as the normal force causes the kinetic friction to build at the brake pad surface 320L (320R) against the wheel rim 180 (see FIG. 13), the brake pad 330L backing (330R) will cause the saddle 345L (345R) to pivot about the shouldered socket head cap screw sets 346L, 347L (346R, 347R). As the saddle pivots, a portion of the bicycle rider inertia will be converted into additional normal force on the brake pad surface as the brake shoe moves through an angular displacement. This will increase the kinetic friction available for stopping the bicycle wheel.

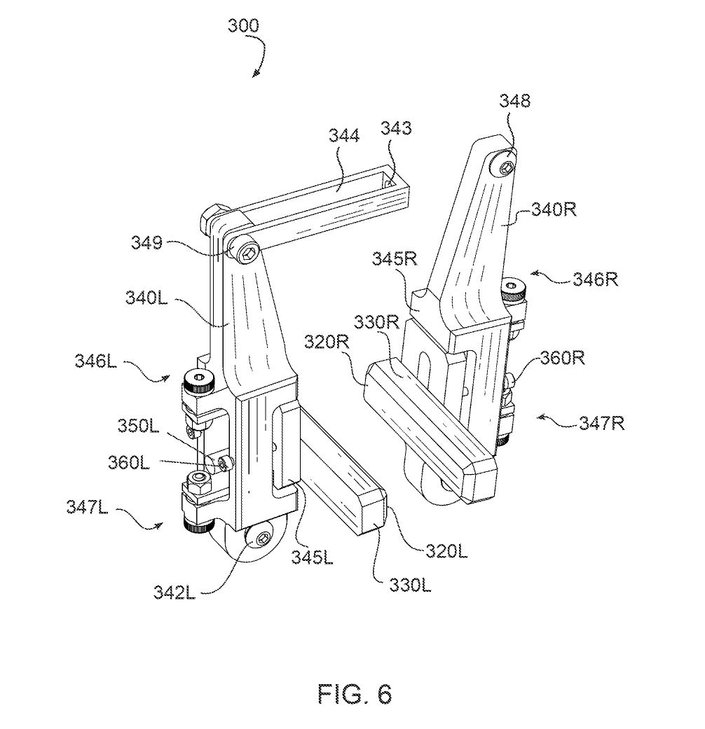

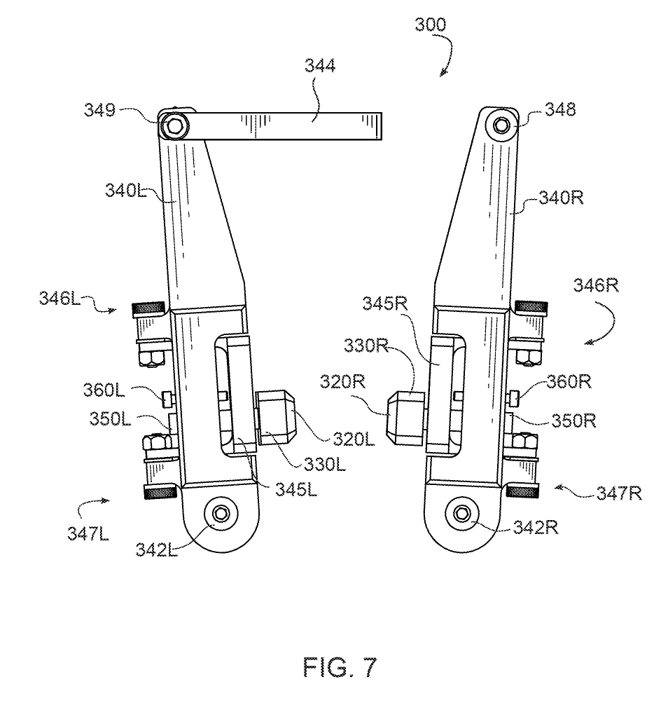

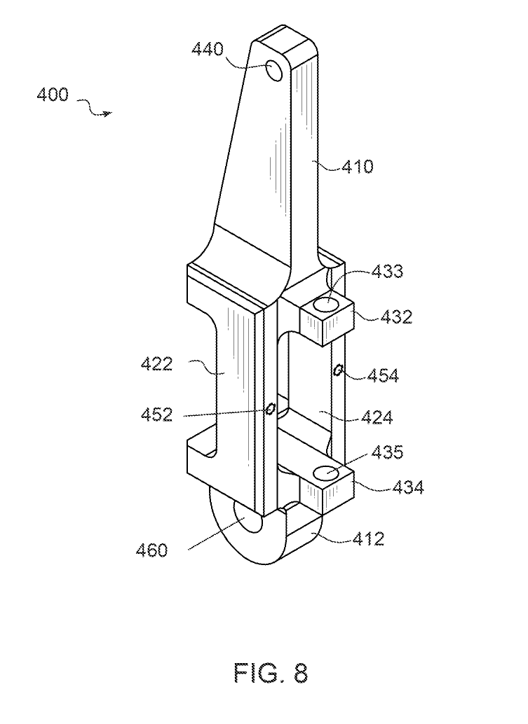

As shown in FIG. 8, a cantilever brake arm 400 of the present invention includes a top portion 410 and a bottom portion 412. The top portion includes a hole 440 drilled or otherwise formed for retaining a bolt to hold a cable keeper 344 or cable retaining bolt 348 (see FIGS. 6-7). The bottom portion includes a hole 460 drilled or otherwise formed for retaining a bolt 342L, 342R for securing the cantilever arm to each arm 196, 198 of a bike frame 190 (see FIGS. 11-14). The central (middle) portion 422 of the cantilever arm is configured with a cavity 424 to retain the saddle 345L, 345R (see also FIG. 10). Flanges 432, 434 are formed with holes (top to bottom) 433, 435 for retaining the shouldered socket head cap screw sets 346L, 347L (346R, 347R) extend outwardly from the cantilever arm body. The flanges are position above and below the central cavity to allow the saddle to be pivotally retained within the cantilever arm. The body of the central portion of the cantilever arm that forms the cavity for retaining the saddle includes holes 452, 454 drilled or otherwise formed on each side of the cavity for retaining the socket head cap screw sets 360L, 370L (360R, 370R).

Referring now to FIG. 10, the saddle 600 of the brake assembly may be made from a high tensile strength aluminum alloy such as 7075-T6, T651. The saddle includes a substantially rectangular body 610 having a top end 612 (toward the rider seat) and a bottom end 614. The middle portion 630 of the saddle body is configured with a substantially rectangular cutout 640 for retaining the connecting rod 350L, 350R attached to the brake pad 330L, 330R (see FIG. 7) within the contour 620 of the saddle. The cutout may have rounded top and bottom edges for use with a cylindrical connecting rod. The top and bottom portions of the saddle are further configured with substantially rectangular elongate arm (flanges) 622, 624 for residing in and securing to the cantilever brake arms 340L, 340R. The distal ends of the elongate flanges include holes 626, 628 for retaining the saddle screws 346L, 346R, 347L, 347R.

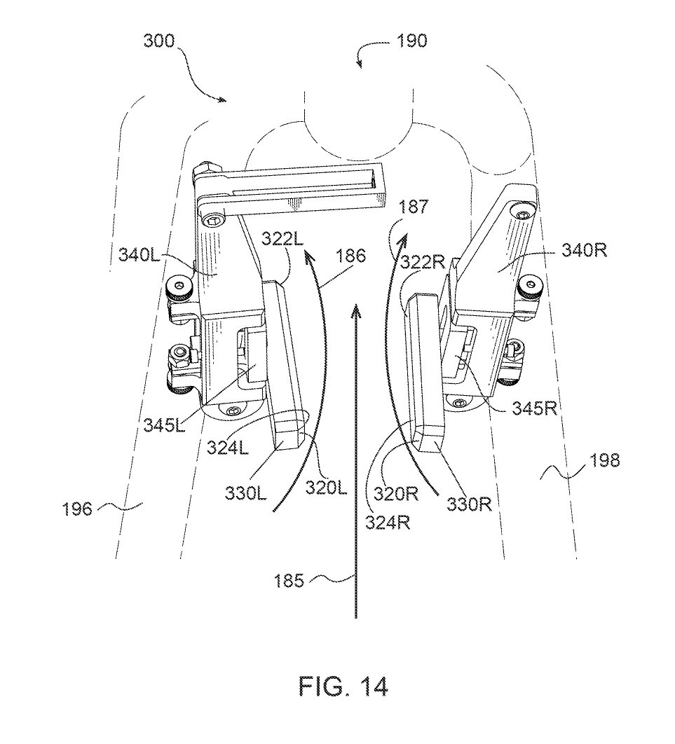

Referring now to FIG. 14, the view is from the perspective of a person standing behind a bicycle 190. As the bicycle moves forward along its path of motion 185, the tire and wheel rotates about its axis such that the rim is moving toward the front of the bicycle as it passes through the brake assembly (see FIG. 12). When each brake shoe is pressed against the wheel rim, the friction at the brake pad frontal portion 322L, 322R of the gripping surface 320R, 320L rotates (arrows 186, 187) the brake shoe backing 330L, 330R and the saddle 345L, 345R about the pivot axis within the brake arm 340L, 340R. This rotation causes the distal portion 324L, 324R of the brake pad to move into the wheel rim while the frontal portion of the pad moves away from the rim (see FIG. 13).

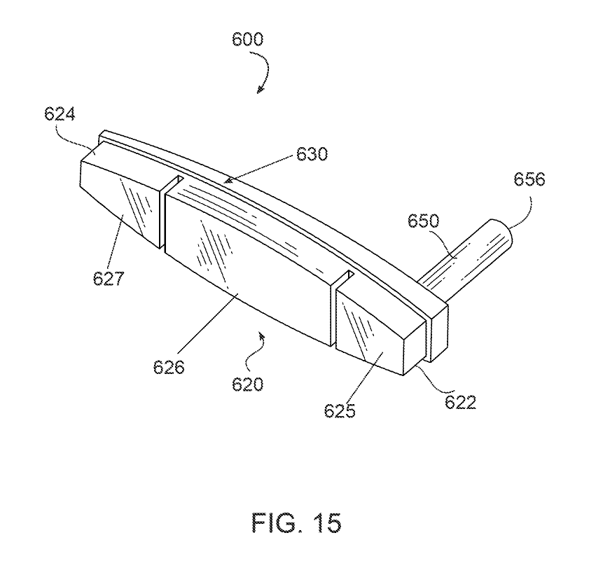

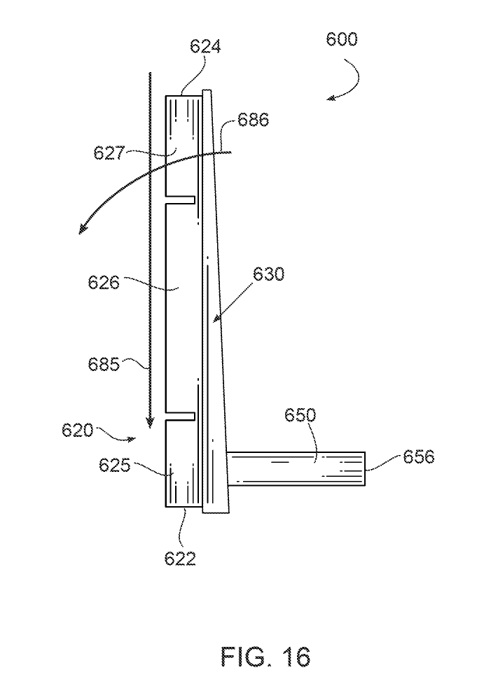

Referring now to FIGS. 15 and 16, an alternative embodiment of the brake shoe 600 is configured to can be mounted on any existing brake arms, and do not require a proprietary brake arm assembly. One of ordinary skill in the art can adapt this embodiment of the brake shoe of the present invention to current and yet to be developed bicycle brake assemblies without undue experimentation. The brake pad 620 and backing 630 are elongated having a connecting rod (mounting post) 650, 656 positioned at a shorter portion 622 (towards the front wheel) so as to form an asymmetric brake shoe. Two or more sections of the brake shoe pad 625, 626, 627 may be made from materials of different hardness (durometer), as can be determined by one of ordinary skill in the art without undue experimentation.

The brake shoe 600 is configured such that a longer portion of the brake pad 624 extends toward the rear of the bicycle (away from the front wheel). As friction builds during braking while the bicycle wheel turns (arrow 685), the shoe backing will flex in toward the rim of the bicycle wheel (arrow 686). The flex of the shoe backing 630 will increase the normal force on the brake pad (gripping surface) 620 against the wheel rim (see FIG. 13), resulting in an increase of kinetic friction between the brake shoe and the wheel rim. This increase in kinetic friction increases the rider's ability to decelerate the bicycle motion for the same force applied at the brake lever.

Those skilled in the art of manufacturing bicycle assemblies such as the disclosed bicycle brakes can determine, without undue experimentation, the appropriate dimensions, geometries, materials, and other features of the bicycle brake apparatus. Other embodiments in accordance with the present invention may be employed as is known to those skilled in the art of designing and/or manufacturing of bicycle brake assemblies. Similarly, those skilled in the art will understand from the disclosure herein that various modifications to the components of the bicycle brake can be made without departing from the scope of the invention. More specifically, the present invention is not limited to any particular method of assembling (manufacturing) the bicycle brake and it components.

While certain aspects of the invention have been illustrated and described herein in terms of its use as a braking assembly for use with a bicycle, modifications and improvements to the disclosed apparatus may be made without departing from the scope of the invention. Accordingly, the scope of the invention is not intended to be limited by, for example, but not limited to, the details of the drawings and the appended claims.

We claim:

1. An apparatus for reducing the angular speed of a bike wheel, comprising:
a first elongate arm;
a first brake shoe having a first backing portion and a first gripping surface secured to the first backing portion, wherein the first gripping surface has a first end portion and a second end portion; and
a first connecting rod secured to the first elongate arm and pivotally secured to the first backing portion of the brake shoe.

2. The apparatus of claim 1, wherein the first connecting rod is secured closer to the first end portion of the first gripping surface than to the second end portion of the first gripping surface.

3. The apparatus of claim 1, wherein the first connecting rod includes a first section and a second section perpendicular to the first section, such that the second section is pivotally retained within the first backing portion.

4. The apparatus of claim 1, further including a first leveling screw disposed within the first elongate arm.

5. The apparatus of claim 1, further including a first force imparting screw disposed within the first elongate arm.

6. The apparatus of claim 5, wherein a first spring is positioned around the force imparting screw.

7. The apparatus of claim 5, wherein an elastomer is positioned around the force imparting screw.

8. The apparatus of claim 1, wherein the first gripping surface is made from at least two materials having a different durometer.

9. The apparatus of claim 1, further including:
a second elongate arm;
a second brake shoe having a second backing portion and a second gripping surface secured to the second backing portion, wherein the second gripping surface has a first end portion and a second end portion; and
a second connecting rod secured to the second elongate arm and pivotally secured to the second backing portion,
wherein the first connecting rod is secured closer to the first end portion of the first gripping surface than to the second end portion of the first gripping surface,
wherein the second connecting rod is secured closer to the first end portion of the second gripping surface than to the second end portion of the second gripping surface,
wherein the first connecting rod includes a first section and a second section perpendicular to the first section, such that the second section of the first connecting rod is pivotally retained within the first backing portion,
wherein the second connecting rod includes a first section and a second section perpendicular to the first section, such that the second section of the second connecting rod is pivotally retained within the second backing portion;
a first leveling screw disposed within the first elongate arm;
a second leveling screw disposed within the second elongate arm;
a first force imparting screw disposed within the first elongate arm; and
a second force imparting screw disposed within the second elongate arm.

10. An apparatus for reducing the angular speed of a bike wheel, comprising:
a first elongate arm;
a first saddle pivotally disposed within the first elongate arm;
a first brake shoe having a first backing portion and a first gripping surface secured to the first backing portion, wherein the first gripping surface has a first end portion and a second end portion; and
a first connecting rod secured to the first backing portion of the first brake shoe, wherein the first connecting rod is disposed with the first saddle.

11. The apparatus of claim 10, wherein the first connecting rod is secured closer to the first end portion of the first gripping surface than to the second end portion of the first gripping surface.

12. The apparatus of claim 10, further including a first leveling screw disposed within the first elongate arm.

13. The apparatus of claim 10, further including a first force imparting screw disposed within the first elongate arm.

14. The apparatus of claim 13, wherein a first spring is positioned around the force imparting screw.

15. The apparatus of claim 13, wherein an elastomer is positioned around the force imparting screw.

16. The apparatus of claim 10, further including:
a second elongate arm;
a second saddle pivotally disposed within the first elongate arm;
a second brake shoe having a second backing portion and a second gripping surface secured to the second backing portion, wherein the second gripping surface has a first end portion and a second end portion; and
a second connecting rod secured to the second backing portion of the second brake shoe, wherein the second connecting rod is disposed with the second saddle,
wherein the first connecting rod is secured closer to the first end portion of the first gripping surface than to the second end portion of the first gripping surface,
wherein the second connecting rod is secured closer to the first end portion of the second gripping surface than to the second end portion of the second gripping surface;
a first leveling screw disposed within the first elongate arm;
a second leveling screw disposed within the second elongate arm;
a first force imparting screw disposed within the first elongate arm; and
a second force imparting screw disposed within the second elongate arm.

17. An apparatus, comprising:
a gripping surface having a first end portion and a second end portion;
a backing portion secured to the gripping surface, wherein the braking portion is formed from a flexible material; and
a connecting rod secured to the second backing portion of the second brake shoe, wherein the connecting rod is secured closer to the first end portion of the gripping surface than to the second end portion of the gripping surface

18. The apparatus of claim 17, wherein the backing portion is made from spring steel.

19. The apparatus of claim 17, wherein the second end of the gripping surface deflects away from the first end of the gripping surface when a force is applied to the connecting rod.

20. The apparatus of claim 17, wherein the gripping surface is made from at least two materials having a different durometer.
